(19) United States
(12) Patent Application Publication
(10) Pub. No.: US 2026/0342801 A1
(43) Pub. Date: Oct. 29, 2026

(54) SIMULATED NETWORK DISRUPTION BASED INTERNET USAGE CONTROLLER APPARATUSES, METHODS, SYSTEMS AND MEDIA

(71) Applicant: Firewalla, San Jose, CA (US)

(72) Inventor: Jianyu Chen, Saratoga, CA (US)

(21) Appl. No.: 19/391,295

(22) Filed: Nov. 17, 2025

Related U.S. Application Data
(60) Provisional application No. 63/722,980, filed on Nov. 20, 2024.

(51) Int. Cl. H04L 9/40

(52) U.S. Cl. CPC H04L 63/104; H04L 63/20

(57) ABSTRACT

A network request data structure is obtained. A device associated with the network request data structure is determined. An activity category associated with the network request data structure is determined. A network usage policy rule data structure associated with the device for the activity category is determined. A policy time limit specified via the network usage policy rule data structure is determined. A determination is made that the policy time limit has been exceeded. A disturb period specified via the network usage policy rule data structure is determined. A determination is made that the disturb period has not been exceeded. An enforcement protocol to utilize for the activity category specified via the network usage policy rule data structure is determined. An enforcement protocol is applied to the network request data structure to simulate a network disruption.

### CROSS-REFERENCE TO RELATED APPLICATIONS

This United States non-provisional patent application claims priority under 35 U.S.C. § 119 to U.S. provisional patent application No. 63/722,980, filed Nov. 20, 2024, entitled “SIMULATED NETWORK DISRUPTION BASED INTERNET USAGE CONTROLLER APPARATUSES, METHODS, SYSTEMS AND MEDIA”, docket no. 163807-0002(P001Z).

This disclosure describes SIMULATED NETWORK DISRUPTION BASED INTERNET USAGE CONTROLLER APPARATUSES, METHODS, SYSTEMS AND MEDIA (hereinafter “SNDBIUC”). A portion of the disclosure of this patent document contains material which is subject to copyright and/or mask work protection. The copyright and/or mask work owners have no objection to the facsimile reproduction by anyone of the patent document or the patent disclosure, as it appears in the Patent and Trademark Office patent file or records, but otherwise reserve all copyright and mask work rights whatsoever.

The entire contents of the aforementioned application are herein expressly incorporated by reference in their entirety.

### FIELD

The present disclosure generally addresses firewalls and more particularly includes SIMULATED NETWORK DISRUPTION BASED INTERNET USAGE CONTROLLER APPARATUSES, METHODS, SYSTEMS AND MEDIA.

### BACKGROUND

Individuals, including children, utilize the internet for a variety of activities such as online gaming, video streaming, and chatting. While such activities can be beneficial, overuse of the internet can have negative effects.

### BRIEF DESCRIPTION OF THE FIGURES

The accompanying figures and/or appendices illustrate various example embodiments in accordance with the present disclosure.

FIG. 1 shows an example of a data flow diagram in one embodiment of the SNDBIUC;

FIG. 2 shows an example of a logic flow diagram illustrating a Network Disruption Rules Configuring (NDRC) component in one embodiment of the SNDBIUC;

FIG. 3 shows an example of screenshot diagram(s) in one embodiment of the SNDBIUC;

FIG. 4 shows an example of a logic flow diagram illustrating an Internet Usage Controller (IUC) component in one embodiment of the SNDBIUC;

FIG. 5 shows an example of screenshot diagram(s) in one embodiment of the SNDBIUC;

FIG. 6 shows an example of a block diagram illustrating an example SNDBIUC coordinator in one embodiment of the SNDBIUC.

### DETAILED DESCRIPTION

### Introduction

When parents disallow their children from accessing the internet or doing any activities such as gaming, or internet videos, it is based on the “block” or “power it down” method. This method will work, but can create problems, e.g., angry children, who do not want to be controlled, and may try to hack around the block.

### Example SNDBIUC Embodiment

In one embodiment, instead of blocking one or more activities, the SNDBIUC may implement a simulated “network problem” to slowly stop a user, such as a child, from using the online resource because their experience is ‘bad’. (e.g., not winning games, waiting for videos to load, randomly not able to visit a site, and/or the like).

For example, if a user is playing games, the SNDBIUC may introduce latency to the network randomly that will likely cause the user to lose the game and then lose interest.

In another example, if the user is watching a video, the SNDBIUC may limit the bandwidth to the user's device, causing the video to be choppy and causing the user to lose interest.

In another example, if the user is watching short videos (e.g., TikTok®), a random slow down or block may cause the learning/AI algorithm to load cached videos, and reduce the ‘addiction’ factor.

### Example SNDBIUC Benefits

In one embodiment, the SNDBIUC may be utilized as a short term internet usage controller solution, e.g., for younger children. Most of the time, children should not know their internet usage is being managed by parents, and may instead believe that there is just bad internet connectivity. Once children start to learn about the controls, parents can augment with and/or migrate to a “blocking” method.

### Example SNDBIUC Components

An activity categorization engine (e.g., implementing a set of activity categorization rules). In one implementation, the activity categorization engine may categorize people's activities, including usage of online resources.

A policy engine (e.g., implementing a set of policy rules). In one implementation, the policy engine may include a policy configuration user interface that may include a policy to “disturb” and that may implement GUI widgets allowing a user (e.g., a parent) to specify: when to start and/or stop disturbing (e.g., after a kid played a game for X minutes); how often disturbing should happen (e.g., every 5,10,15.20 minutes+random); criteria for disturbing (e.g., the use of specific online resources, the detection of specific online activities); and/or the like.

A policy enforcement engine (e.g., implementing policy enforcement rules). In one implementation, the policy enforcement engine may include policy enforcement protocols (e.g., functions) such as, but not limited to: increase artificial latency, random drop packets, rate limit activities, and/or the like.

The policy enforcement engine may determine what policy enforcement protocols to use based on the activity type (e.g., in accordance with the policy enforcement rules). For example:
a. Gaming: introduce latency and random drop packets
b. Video: rate limit and random drop packets
c. Chatting: drop packets 90% (for example)
d. In one implementation, the policy enforcement engine may be structured as a time-varying system. Once the disturb happens, the system may slowly increase the threshold of the disturbances, e.g., exponentially. Once the disturb period is over, the network may be normal for some duration (e.g., for ½ of the disturb period) and disturbance may happen again.
e. In one embodiment, the policy enforcement engine may be structured to simulate a website, application, LAN, and/or the like network issue.

An impact measurement component. In one implementation, the impact measurement component may measure if a user's (e.g., child's) internet activity usage has decreased when the “disturbance” is on. In one embodiment, such measurement data may give controlling users (e.g., parents) feedback regarding the effectiveness of the current settings.

### Other SNDBIUC Embodiments

A System for Utilizing Simulated Network Disruptions to Discourage Internet-Based Activities in Children

Parents may manage their children's internet usage by either blocking access or powering down devices. While effective, these methods often lead to frustration, resulting in children attempting to bypass restrictions or becoming resentful toward parental controls.

In one embodiment, the SNDBIUC implements an approach to managing children's internet activities by simulating poor network conditions. Rather than outright blocking access, this system subtly degrades the user experience, causing children to lose interest in activities like gaming or streaming videos due to the perceived ‘bad’ network performance. For example:
a. Gaming: Introducing random latency or packet loss, causing the child to lose games, thereby reducing their interest in continuing.
b. Video Streaming: Limiting bandwidth to the child's device, resulting in choppy video playback, which discourages further viewing.

Example benefits may include:
a. Stealth Management: Children are less likely to realize they are being managed by their parents.
b. Flexibility: Once children become aware of the controls, parents may transition to more direct blocking methods.
c. Short-Term Solution: May be utilized as a temporary measure to manage internet usage effectively.

Example details may include:

### 1. Activity Categorization:

Activities are categorized, such as gaming, video streaming, chatting, and/or the like.

### 2. Policy Engine:

A ‘disturb’ policy rule:
a. When to Disturb: For example, after the child has been playing a game for a set number of minutes.
b. Frequency of Disturbance: Occurs at intervals of 5, 10, 15, or 20 minutes, with added randomness.

### 3. Policy Enforcement Engine:

In one embodiment, functions such as (but not limited to) the following may be implemented:
a. Artificial Latency: Introduce delays in network traffic.
b. Random Packet Drops: Randomly discard packets to simulate poor network conditions.
c. Rate Limiting: Control the bandwidth available to the child's device.

### 4. Activity-Specific Disturbances:

a. Gaming: Introduce latency and random packet drops.
b. Video Streaming: Implement bandwidth throttling and random packet drops.
c. Chatting: Drop a high percentage of packets (e.g., 90%).

### 5. Time-Varying (e.g., Exponential) Disturbance Increase:

The system gradually increases the severity of disturbances. After a disturbance period, the network returns to normal for some time (e.g., half the disturbance period), before resuming disruption.

### 6. Simulating Issues:

In one embodiment, the system may operate to mimic real network or application problems, making it difficult for the child to detect that the disruptions are intentional.

### 7. Measurement and Feedback:

The system monitors the child's internet usage during disturbances, providing feedback to parents on the effectiveness of the intervention.

### Other SNDBIUC Embodiment Examples

1. A system for managing internet usage by simulating poor network conditions, comprising:
an activity categorization module;
a policy engine for determining when and how to introduce disturbances;
a policy enforcement engine capable of increasing latency, dropping packets, and rate limiting; and
a feedback mechanism to measure the effectiveness of disturbances on reducing internet usage.

2. The system of embodiment example 1, wherein the policy engine applies disturbances based on the type of activity, with gaming receiving latency and packet drops, video streaming experiencing bandwidth throttling, and chatting subjected to a high packet drop rate.

3. The system of embodiment example 1, wherein the severity of disturbances increases exponentially overtime, with a period of normal network conditions following each disturbance cycle.

4. The system of embodiment example 1, wherein the disturbances mimic real network issues, making it challenging for a user to detect control measures.

5. The system of embodiment example 1, wherein a feedback mechanism tracks changes in a user's internet usage, providing insights to controlling users on the system's effectiveness.

### DETAILED DESCRIPTION OF THE SNDBIUC

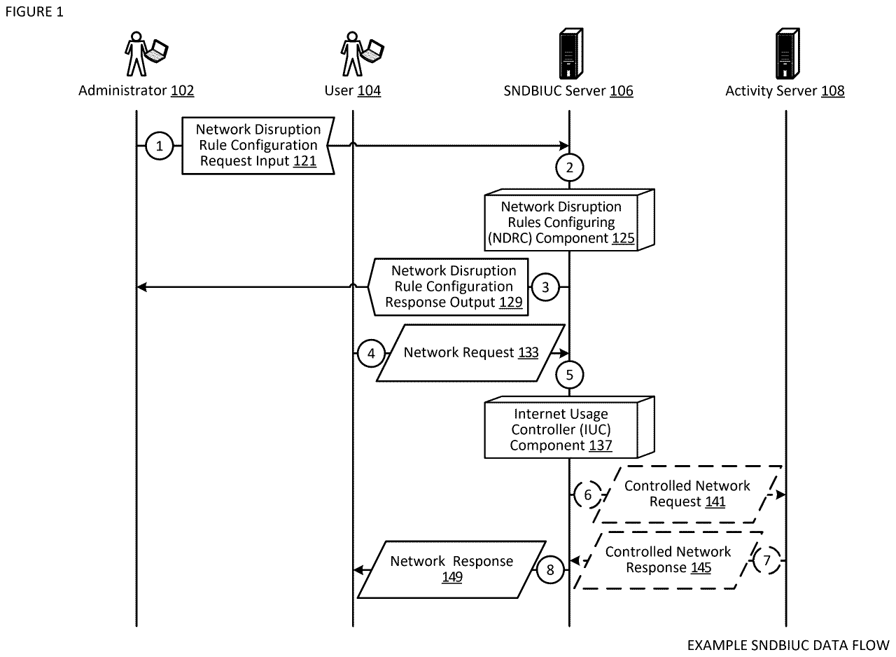

FIG. 1 shows an example of a data flow diagram in one embodiment of the SNDBIUC. In FIG. 1, dashed lines indicate data flow elements that may be included in particular implementations. FIG. 1 provides an example of how data may flow to, through, and/or from the SNDBIUC. In FIG. 1, an administrator 102 (e.g., a parent) may send a network disruption rule configuration request input 121 to a SNDBIUC server 106 (e.g., a router, a firewall, and/or the like), such as to facilitate configuring a network usage (e.g., internet usage) policy rule for a set of devices. In one embodiment, the administrator may use a client (e.g., a desktop, a laptop, a tablet, a smartphone, a smartwatch, and/or the like) to access a SNDBIUC website, application (e.g., a desktop application, a mobile app), and/or the like to facilitate generating the network disruption rule configuration request input. In one implementation, the network disruption rule configuration request input may include data such as, but not limited to, a request identifier, affected user group identifiers, affected user identifiers, affected device identifiers (e.g., via device names, IP addresses, MAC addresses, and/or the like), matching activity types (e.g., activity types, applications, websites), a time limit, an enforcement protocols type, enforcement protocols details, a disturb period, and/or the like. For example, the network disruption rule configuration request input may be sent via a network in XML format similar to the following example form:

```
<?XML version = “1.0” encoding = “UTF-8”?>
<network_disruption_rule_configuration_request_input>
  <request_identifier>ID_request_1</request_identifier>
  <user_identifier>ID_admin_parent</user_identifier>
  <credential_token>user's credential token for authentication</credential_token>
  <affected_user_group_identifiers>ID_kids_devices</affected_user_group_identifiers>
  <matching_activity_types>
    <applications>YouTube</applications>
    <websites>youtube.com</websites>
  </matching_activity_types>
  <time_limit>1 hour per day on weekdays</time_limit>
  <enforcement_protocols_type>MANUAL</enforcement_protocols_type>
  <enforcement_protocols_details>
    <enforcement_protocol>
      <type>TYPE_RATE_LIMIT</type>
      <severity_level>DYNAMIC</severity_level>
    </enforcement_protocol>
    <enforcement_protocol>
      <type>TYPE_DROP_PACKETS </type>
      <severity_level>DYNAMIC</severity_level>
    </enforcement_protocol>
  </enforcement_protocols_details>
  <disturb_period>1 hour</disturb_period>
</network_disruption_rule_configuration_request_input>
```

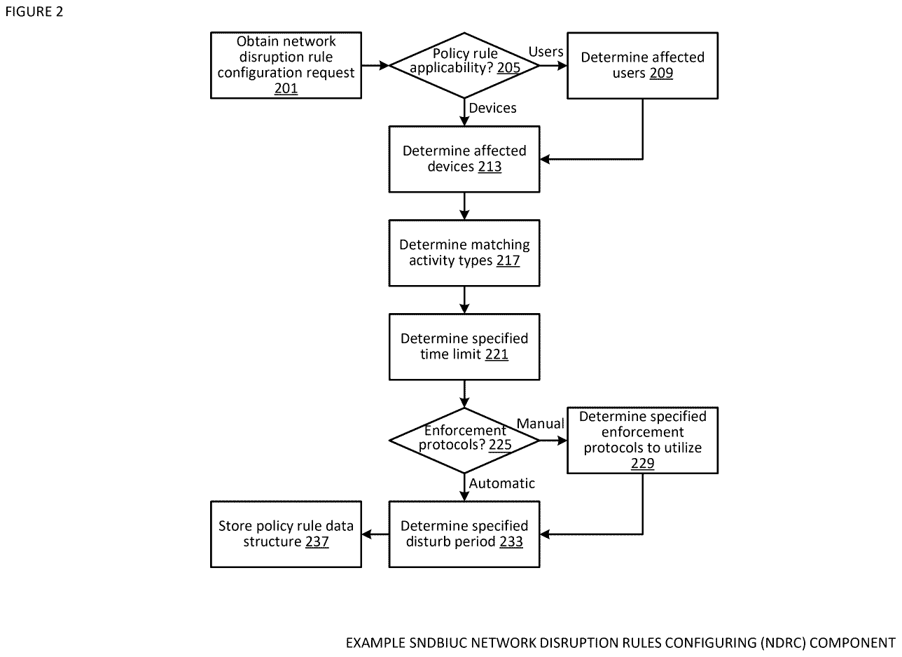

A network disruption rules configuring (NDRC) component 125 may utilize data provided in the network disruption rule configuration request input to configure (e.g., to initiate operation of) the network usage (e.g., internet usage) policy rule for the set of devices. See FIG. 2 for additional details regarding the NDRC component.

The SNDBIUC server 106 may send a network disruption rule configuration response output 129 to the admin client 102 to inform the administrator whether the network usage policy rule for the set of devices was configured successfully. In one implementation, the network disruption rule configuration response output may include data such as a response identifier, a status, and/or the like. For example, the network disruption rule configuration response output may be sent via a network in XML format similar to the following example form:

```
<?XML version = “1.0” encoding = “UTF-8”?>
<network_disruption_rule_configuration_response_output>
  <response_identifier>ID_response_1</response_identifier>
  <status>OK</status>
</network_disruption_rule_configuration_response_output>
```

A user 104 (e.g., a child) may facilitate sending a network request 133 to the SNDBIUC server 106 to engage in a network usage (e.g., internet usage) activity. In one embodiment, the user may utilize an application (e.g., YouTube®), access a website (e.g., youtube.com) via a web browser, and/or the like via the user's client (e.g., a desktop, a laptop, a tablet, a smartphone, a smartwatch, and/or the like), such as to engage in the network usage activity (e.g., video streaming), and the network request (e.g., a network packet) may be generated (e.g., via the application, via the web browser) to facilitate operation of the network usage activity (e.g., to stream a video). In one implementation, the network request may include data such as, but not limited to, a request identifier, network usage activity request data, and/or the like. For example, the network request may be sent via a network in XML format similar to the following example form:

```
<?XML version = “1.0” encoding = “UTF-8”?>
<network_request>
  <request_identifier>ID_request_2</request_identifier>
  <network_usage_activity_request_data>
    Request data specific to activity
  </network_usage_activity_request_data>
</network_request>
```

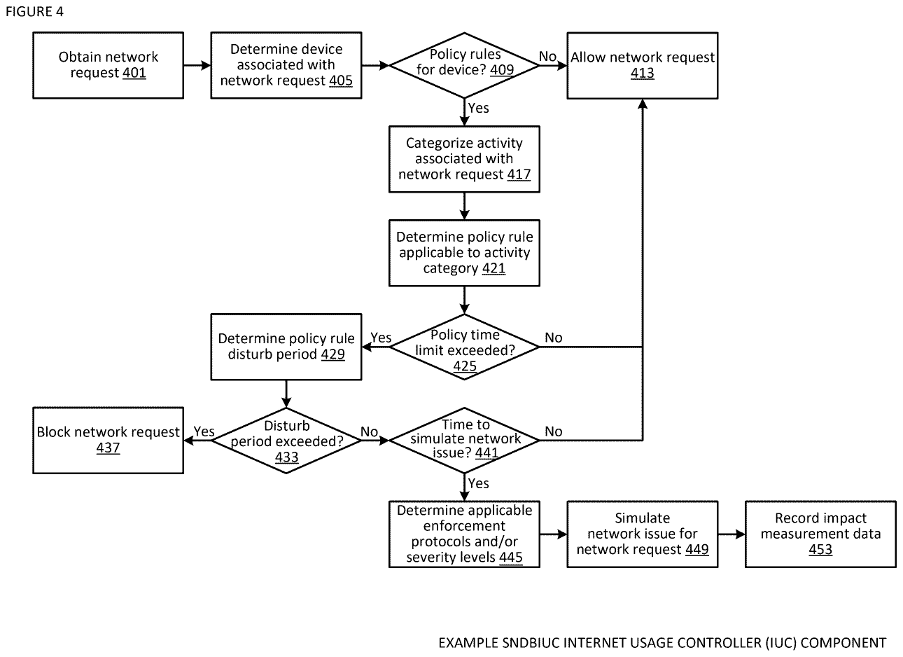

An internet usage controller (IUC) component 137 may utilize data provided in the network request to evaluate and/or control allowability of the network request in accordance with configured network usage policy rules. It is to be understood that, although the network request is described above using XML format for ease of understanding, the network request processed by the IUC component may take other forms, such as but not limited to: a TCP segment, a UDP datagram, an IP packet, an Ethernet frame, and/or the like. See FIG. 4 for additional details regarding the IUC component.

In some embodiments (e.g., when the IUC component determines that the network request is allowable), the SNDBIUC server 106 may send a controlled network request 141 to an activity server 108, such as to facilitate operation of the network usage activity. It is to be understood that the controlled network request (e.g., utilized to forward (e.g., packet forwarding) the network request) may be sent in accordance with enforcement protocols applied by the IUC component to the network request. For example, the controlled network request (e.g., a network packet) may be sent with a delay to simulate a network issue (e.g., rate limiting). In one implementation, the controlled network request may include data such as, but not limited to, a request identifier, network usage activity request data, and/or the like. For example, the controlled network request may be sent via a network in XML format similar to the following example form:

```
<?XML version = “1.0” encoding = “UTF-8”?>
<controlled_network_request>
  <request_identifier>ID_request_3</request_identifier>
  <network_usage_activity_request_data>
    Request data specific to activity
  </network_usage_activity_request_data>
</controlled_network_request>
```

In some embodiments (e.g., in response to the controlled network request), the activity server 108 may send a controlled network response 145 to the SNDBIUC server 106 with response data associated with the network usage activity. In one implementation, the controlled network response (e.g., a network packet) may include data such as, but not limited to, a response identifier, the response data associated with the network usage activity, and/or the like. For example, the controlled network response may be sent via a network in XML format similar to the following example form:

```
<?XML version = “1.0” encoding = “UTF-8”?>
<controlled_network_response>
  <response_identifier>ID_response_3</response_identifier>
  <network_usage_activity_response_data>
    Response data specific to activity
  </network_usage_activity_response_data>
</controlled_network_response>
```

The SNDBIUC server 106 may send a network response 149 to the user client 104 in response to the network request. In some embodiments (e.g., when the IUC component determines that the network request is allowable), the network response (e.g., a network packet) may comprise response data associated with the network usage activity. It is to be understood that the network response may be sent in accordance with enforcement protocols applied by the IUC component to the network request. For example, the network response may be sent with a delay to simulate a network issue (e.g., rate limiting). In one implementation, the network response may include data such as, but not limited to, a response identifier, the response data associated with the network usage activity, and/or the like. For example, the network response may be sent via a network in XML format similar to the following example form:

```
<?XML version = “1.0” encoding = “UTF-8”?>
<network_{——}response>
  <response_identifier>ID_response_2</response_identifier>
  <network_usage_activity_response_data>
    Response data specific to activity
  </network_usage_activity_response_data>
</network_{——}response>
```

In some embodiments (e.g., when the IUC component determines that the network request is blocked), the network response (e.g., a network packet) may comprise an error message (e.g., to simulate a Domain Name System (DNS) server error) or may not be sent (e.g., to simulate a dropped packet). In one implementation, the network response may include data such as, but not limited to, a response identifier, error data, and/or the like. For example, the network response may be sent via a network in XML format similar to the following example form:

```
<?XML version = “1.0” encoding = “UTF-8”?>
<network_{——}response>
  <response_identifier>ID_response_2</response_identifier>
  <error_data>RCODE:3 (NXDOMAIN - Domain name does
  not exist)</error_data>
</network_{——}response>
```

FIG. 2 shows an example of a logic flow diagram illustrating a Network Disruption Rules Configuring (NDRC) component in one embodiment of the SNDBIUC. In FIG. 2, a network disruption rule configuration request may be obtained at 201. For example, the network disruption rule configuration request may be obtained as a result of a request (e.g., via a network disruption rule configuration request input) from an administrator (e.g., a parent) to configure a network usage (e.g., internet usage) policy rule for a set of devices.

A determination may be made at 205 regarding the network usage policy rule applicability. In some embodiments, the network usage policy rule may be specified for a set of affected users. If so, the set of affected users may be determined at 209. For example, the set of affected users may be specified via a set of user identifiers (e.g., ID_kid_1, ID_kid_2). In another example, the set of affected users may be specified via a set of user group identifiers (e.g., ID_kids_devices), in which a user group identifier may correspond to a set of user identifiers. In one implementation, the network disruption rule configuration request may be parsed (e.g., using PHP commands) to determine the set of affected users (e.g., based on the value(s) of the affected_user_identifiers, affected_user_group_identifiers field(s)). A set of affected devices associated with the set of affected users may be determined at 213. In one implementation, the set of affected devices may be determined via the users data store 630a. For example, the set of affected devices may be determined via one or more SQL statements similar to the following example form:

SELECT UserAssociatedClientIDs
FROM Users
WHERE UserID IN (list of user identifiers for the set of affected users);

In some embodiments, the network usage policy rule may (e.g., instead, also) be specified for a set of affected devices. For example, the set of affected devices may be specified via device (e.g., client) identifiers (e.g., administrator assigned names), device IP addresses, device MAC addresses, and/or the like. The set of affected devices may be determined at 213. In one implementation, the network disruption rule configuration request may be parsed (e.g., using PHP commands) to determine the set of affected devices (e.g., based on the value of the affected_device_identifiers field).

A set of matching activity types for the network usage policy rule may be determined at 217. In various embodiments, the set of matching activity types may comprise activity types (e.g., online gaming, video streaming, chatting, and/or the like), applications (e.g., YouTube® app, Roblox® game, and/or the like), websites (e.g., youtube.com, facebook.com, and/or the like) domains, subdomains, top-level domains, paths, protocols, etc., and/or the like matching activity type parameters. In one implementation, the network disruption rule configuration request may be parsed (e.g., using PHP commands) to determine the set of matching activity types (e.g., based on the value of the matching_activity_types field).

A time limit for the network usage policy rule may be determined at 221. In one embodiment, the time limit may be a threshold time length (e.g., 1 hour) for an indicated time period (e.g., per day during weekdays) after which an enforcement protocol may be applied to a device in the set of affected devices when engaging in an activity in the set of matching activity types. In various embodiments, the time limit may be configured to accumulate per each device (e.g., across any IP addresses and/or MAC addresses associated with the device), per each user (e.g., across any devices associated with a kid), per each user group (e.g., across any kids' devices), and/or the like, and/or may be further filtered to accumulate when using a specified network type (e.g., mobile hotspot, Wi-Fi, Ethernet, and/or the like), during a specified time of day (e.g., between 9 am and 5 pm), during specified network performance levels (e.g., during periods of high network congestion resulting in above threshold rate(s) of packet loss, bandwidth usage, latency, and/or the like), and/or the like. In one implementation, the network disruption rule configuration request may be parsed (e.g., using PHP commands) to determine the time limit (e.g., based on the value of the time_limit field).

A determination may be made at 225 whether enforcement protocols for the network usage policy rule are stipulated to be specified (e.g., determined as applicable for the network usage policy rule and/or selected (e.g., type, severity level) during a disturb period enforcement instance) automatically. In one implementation, the network disruption rule configuration request may be parsed (e.g., using PHP commands) to make this determination (e.g., based on the value of the enforcement_protocols_type field).

If enforcement protocols for the network usage policy rule are stipulated to be specified manually (e.g., by the administrator), the specified enforcement protocols to utilize may be determined at 229. For example, enforcement protocols may include, but are not limited to, increase latency, drop packets, rate limit, and/or the like. In one implementation, the network disruption rule configuration request may be parsed (e.g., using PHP commands) to determine the specified enforcement protocols to utilize (e.g., based on the value of the enforcement_protocols_details field).

A specified disturb period for the network usage policy rule may be determined at 233. In one embodiment, the disturb period may be a threshold time length (e.g., 1 hour), after the time limit has been exceeded, during which an enforcement protocol may be applied to a device in the set of affected devices when engaging in an activity in the set of matching activity types to simulate a network disruption (e.g., before blocking activities in the set of matching activity types completely for the indicated time period (e.g., for the day)). In one implementation, the network disruption rule configuration request may be parsed (e.g., using PHP commands) to determine the disturb period (e.g., based on the value of the disturb_period field).

A policy rule data structure defining the network usage policy rule may be stored at 237. In one implementation, the policy rule data structure may be stored via the policy rules data store 630c. For example, the policy rule data structure may be stored via one or more SQL statements similar to the following example form:

INSERT INTO PolicyRules (PolicyRuleID,
PolicyRuleAffectedUserGroupIDs, PolicyRuleMatchingActivityTypes,
PolicyRuleTimeLimit, PolicyRuleEnforcementProtocolsType,
PolicyRuleEnforcementProtocolsDetails, PolicyRuleDisturbPeriod)
VALUES (ID_POLICY_RULE_1, ID_kids_devices,
“APPLICATIONS:YouTube, WEBSITES:youtube.com”, “1 hour per
day on weekdays”, MANUAL, “TYPE_RATE_LIMIT: DYNAMIC,
TYPE_DROP_PACKETS: DYNAMIC”, “1 hour”);

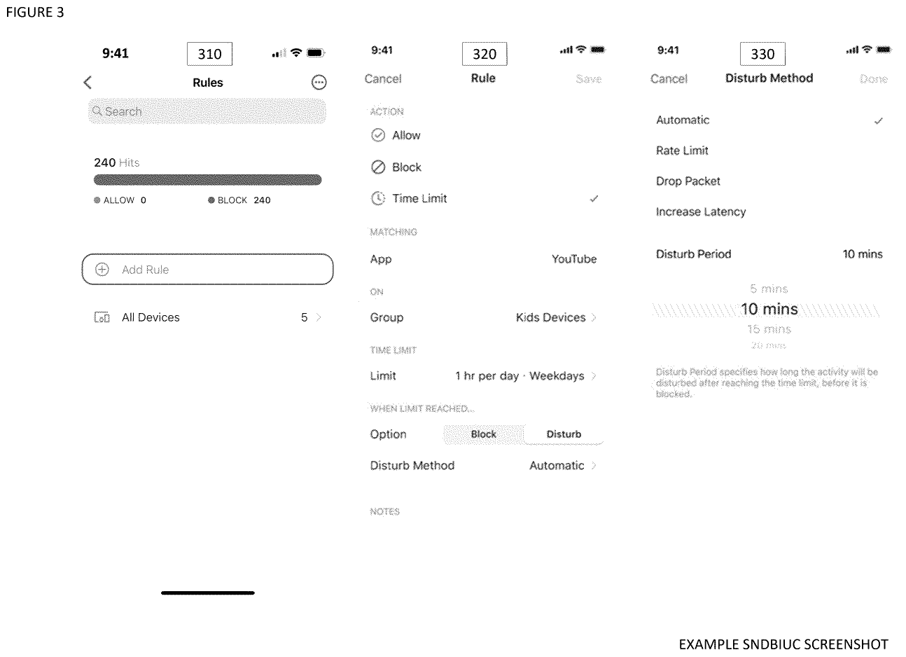

FIG. 3 shows an example of screenshot diagram(s) in one embodiment of the SNDBIUC. In FIG. 3, an example user interface (e.g., for a mobile device, for a website, and/or the like) for configuring network usage policy rules is illustrated. Screen 310 shows that a user may utilize an Add Rule widget to add a policy rule. Screen 320 shows that the user may select a Time Limit action, specify a matching activity type (e.g., for YouTube app) for which the action applies, specify a time limit (e.g., 1 hour per day on weekdays), select an enforcement type (e.g., Disturb) to utilize once the time limit is reached, specify enforcement protocols to utilize (e.g., automatic selection), and/or the like. Screen 330 shows that the user may select one or more enforcement protocols to utilize for the matching activity type and/or may specify a disturb period (e.g., 10 minutes) during which network disruptions are simulated for the matching activity type before blocking the matching activity type completely for the day.

FIG. 4 shows an example of a logic flow diagram illustrating an Internet Usage Controller (IUC) component in one embodiment of the SNDBIUC. In FIG. 4, a network request may be obtained at 401. For example, the network request may be obtained as a result of a user (e.g., a child) of a network subject to internet usage control by the SNDBIUC (e.g., as configured by an administrator (e.g., a parent)) engaging in an internet-based activity (e.g., online gaming, video streaming, chatting, and/or the like).

A device associated with the network request may be determined at 405. In one embodiment, a router service, a firewall service, and/or the like component (e.g., of a SNDBIUC server) may be utilized to determine which device is associated with the network request. In one implementation, the network request (e.g., a network packet) may be examined to determine an associated MAC address and/or IP address. For example, a header section of an IP packet may be parsed (e.g., using PHP commands) to determine the value of a source IP address field. The associated MAC address and/or IP address may be mapped to a device (e.g., a smartphone) and/or to an associated user (e.g., the smartphone may be assigned to the child). In one implementation, the device associated with the network request may be determined via the clients data store 630b. For example, the device may be determined via one or more SQL statements similar to the following example form:

SELECT ClientID
FROM Clients
WHERE ClientIP_Address = “determined IP address”;

In one implementation, the user associated with the network request may be determined via the users data store 630a. For example, the user may be determined via one or more SQL statements similar to the following example form:

SELECT UserID
FROM Users
WHERE UserAssociatedClientIDs LIKE “%determined ClientID%”;

A determination may be made at 409 whether there are network usage policy rules applicable to the device. In one embodiment, network usage policy rules may be applied to the device (e.g., via a device (client) identifier, via an IP address, via a MAC address, and/or the like). In another embodiment, network usage policy rules may be applied to the user (e.g., via a user identifier, via a user group identifier, and/or the like) and a device assigned to the user may be subject to the network usage policy rules (e.g., as configured by the administrator). For example, if the device associated with the network request is assigned to the child, the device may be subject to network usage policy rules for internet-based activities.

If the device is not subject to network usage policy rules (e.g., the parent's smartphone), the SNDBIUC may allow the network request to proceed without simulating network issues at 413.

If the device is subject to network usage policy rules (e.g., the child's smartphone), the SNDBIUC may categorize an activity associated with the network request at 417. In one embodiment, an activity type (e.g., online gaming, video streaming, chatting, and/or the like), an application (e.g., YouTube® app, Roblox® game, and/or the like), a website (e.g., youtube.com, facebook.com, and/or the like), and/or the like associated with the network request may be determined. In one implementation, the router service and/or the firewall service may be utilized to examine network flows to predict and/or determine the activity type, application, website, and/or the like associated with the network request. For example, a header section of an IP packet may be parsed (e.g., using PHP commands) to determine the value of a destination IP address field, which may be utilized (e.g., via a map of known IP addresses to applications and/or via a map of known applications to activity types) to categorize the activity associated with the network request. In various embodiments, data such as destination IP address, port, protocol, application identifier, activity content (e.g., analysis of keywords), and/or the like may be analyzed (e.g., via rules and/or AI) to categorize the activity (e.g., to determine the activity type, application, website, and/or the like associated with the network request).

A network usage policy rule applicable to the determined activity category (e.g., activity type, application, website, and/or the like) associated with the network request may be determined at 421. In one embodiment, the administrator may specify the amount of time (e.g., per hour, per period, per day, per week, and/or the like) that the user is allowed to engage in various matching activity types via network usage policy rules. In one implementation, network usage policy rules associated with the device and/or the user may be analyzed to determine an applicable network usage policy rule (e.g., a best matching network usage policy rule (e.g., most specific, such that for a YouTube© app, a network usage policy rule for YouTube® is applied, but not a network usage policy rule for video streaming), multiple network usage policy rules (e.g., such that for a YouTube® app, both a network usage policy rule for YouTube® and a network usage policy rule for video streaming are applied)) by comparing the determined activity type, application, website, and/or the like associated with the network request with matching activity types of network usage policy rules associated with the device and/or the user. For example, the applicable network usage policy rule may be structured to specify that the user is allowed to engage in video streaming for no more than two hours per day. In another example, the applicable network usage policy rule may be structured to specify that the user is allowed to use YouTube® (e.g., app, website, and/or the like) for no more than one hour per day on weekdays. In one implementation, the applicable network usage policy rule may be determined via the policy rules data store 630c. For example, the applicable network usage policy rule may be determined via one or more SQL statements similar to the following example form:

SELECT PolicyRuleID
FROM PolicyRules
WHERE PolicyRuleMatchingActivityTypes LIKE “%YouTube%” AND
PolicyRuleAffectedClientIDs LIKE “%determined ClientID%”;

A determination may be made at 425 whether a policy rule time limit specified by the applicable network usage policy rule has been exceeded. For example, the child engaged in video streaming for more than two hours today. In another example, the child used the YouTube® app for more than one hour today. In one implementation, the policy rule time limit may be determined via the policy rules data store 630c. For example, the policy rule time limit may be determined via one or more SQL statements similar to the following example form:

SELECT PolicyRuleTimeLimit
FROM PolicyRules
WHERE PolicyRuleID = “determined PolicyRuleID”;

If the policy rule time limit has not been exceeded, the SNDBIUC may allow the network request to proceed without simulating network issues at 413.

If the policy rule time limit has been exceeded, a disturb period specified by the applicable network usage policy rule may be determined at 429. For example, the disturb period may be a threshold time length (e.g., one hour), after the time limit has been exceeded, during which network disruptions may be simulated for YouTube® (e.g., app, website, and/or the like) for the device and/or for the user (e.g., for other devices associated with the child) before YouTube® is blocked completely for the device and/or for the user for the day. In one implementation, the disturb period may be determined via the policy rules data store 630c. For example, the disturb period may be determined via one or more SQL statements similar to the following example form:

SELECT PolicyRuleDisturbPeriod
FROM PolicyRules
WHERE PolicyRuleID = “determined PolicyRuleID”;

A determination may be made at 433 whether the disturb period specified by the applicable network usage policy rule has been exceeded. For example, the child used the YouTube® app for an additional hour after the two-hour policy rule time limit (e.g., for a total of three hours). If the disturb period specified by the applicable network usage policy rule has been exceeded, the SNDBIUC may block the network request at 437.

If the disturb period specified by the applicable network usage policy rule has not been exceeded, a determination may be made at 441 whether it is time to simulate a network issue. In one implementation, the applicable network usage policy rule may be structured to specify that network disruptions should be simulated for matching activity types during the disturb period. For example, the applicable network usage policy rule may be structured to specify a frequency of disturbance (e.g., occurs at disturbance intervals of 10 minutes plus or minus a random duration, occurs at disturbance intervals determined dynamically based on analysis (e.g., via artificial intelligence (AI) and/or machine learning (ML)) of impact measurement data, and/or the like) during the disturb period. In one embodiment, the SNDBIUC may increase the severity of simulated network disruptions during a disturbance interval (e.g., linearly, quadratically, exponentially, and/or the like), then pause simulating network disruptions during a pause interval (e.g., half of the disturbance interval, determined dynamically based on analysis of impact measurement data, and/or the like), before starting a new disturbance interval.

If it is not time to simulate a network issue (e.g., during a pause interval), the SNDBIUC may allow the network request to proceed without simulating network issues at 413.

If it is time to simulate a network issue, applicable enforcement protocols and/or associated severity levels for the determined activity category associated with the network request may be determined at 445. For example, enforcement protocols may include, but are not limited to, increase latency, drop packets, rate limit, and/or the like. In one embodiment (e.g., the administrator specifies enforcement protocols), the applicable network usage policy rule may be structured to specify a set of enforcement protocols to utilize for the determined activity category. In one implementation, the set of enforcement protocols to utilize for the determined activity category may be determined via the policy rules data store 630c. For example, the set of enforcement protocols to utilize for the determined activity category may be determined via one or more SQL statements, such as similar to the following example form:

SELECT PolicyRuleEnforcementProtocolsDetails
FROM PolicyRules
WHERE PolicyRuleID = “determined PolicyRuleID”;

In another embodiment (e.g., the applicable network usage policy rule specifies automatic selection of enforcement protocols), a set of enforcement protocols to utilize for the determined activity category may be specified via corresponding policy enforcement rules (e.g., if gaming activity type is detected, use increase latency and drop packets enforcement protocols; if video streaming activity type is detected, use rate limit and drop packets enforcement protocols). In one implementation, the set of enforcement protocols to utilize for the determined activity category may be dynamic. For example, the set of enforcement protocols to utilize may be controlled from the cloud (e.g., with policy enforcement rules updates downloaded automatically) and/or may be customized for different activity types (e.g., for gaming), applications (e.g., for a specific application), websites (e.g., for a specific website), and/or the like. Accordingly, the set of enforcement protocols to utilize for one game (e.g., Roblox®) and another game (e.g., League of Legends®) may be different. In another example, the set of enforcement protocols to utilize and/or severity level (e.g., magnitude and/or frequency of network disruptions) of enforcement protocols may be selected in accordance with their effectiveness (e.g., as determined via analysis (e.g., via AI and/or ML) of impact measurement data) on the user (e.g., if one set of enforcement protocols is ineffective, another set of enforcement protocols may be utilized; if lower severity level network disruptions (e.g., small increases in latency) are ineffective, higher severity level network disruptions (e.g., large increases in latency) may be utilized; if shorter disturbance intervals are ineffective, longer disturbance intervals may be utilized; if longer pause intervals are ineffective, shorter pause intervals may be utilized). It is to be understood that the set of enforcement protocols to utilize and/or severity level of enforcement protocols may be selected for the disturb period at the start of the disturb period and/or may be adjusted during the disturb period (e.g., in real time). For example, if the child is still watching YouTube videos after some period of time (e.g., after one disturbance interval), the set of enforcement protocols to utilize and/or severity level of enforcement protocols may be adjusted (e.g., for a subsequent (e.g., the next) disturbance interval).

A network issue for the network request may be simulated at 449. In one implementation, network disruptions corresponding to the set of enforcement protocols to utilize for the activity type may be simulated. For example, rate limiting, packet drops, and/or the like network disruptions may be applied to the network request. In one embodiment, the network disruptions may be structured to simulate a website, application, LAN, and/or the like network issue. In one implementation, a controlled network request corresponding to the network request may be forwarded to an activity server with a delay and/or a controlled network response from the activity server corresponding to the network request may be forwarded to the device via a network response with a delay. In another implementation, a network response corresponding to the network request may comprise an error message and/or the network request may be ignored (e.g., a network response may not be sent).

Impact measurement data associated with the set of utilized enforcement protocols for the determined activity category associated with the network request may be recorded at 453. For example, impact measurement data may include data such as the user (e.g., a user identifier, a user group identifier, and/or the like), the activity category (e.g., activity type, application, website, and/or the like), the set of utilized enforcement protocols and/or associated severity levels, duration of the user's engagement in the internet-based activity after the policy time limit has been exceeded, changes in the user's activity type and/or usage patterns, and/or the like. In one implementation, the impact measurement data may be stored in a data store (e.g., in a database). In one embodiment, the impact measurement data may be analyzed (e.g., via AI and/or ML) to determine effectiveness (e.g., once the disturb period started, how many minutes or disturbance intervals it took until the user stopped the internet-based activity) of the set of enforcement protocols (e.g., to inform the parent, automatically implement network usage policy rule and/or policy enforcement rule adjustments, and/or the like). In another embodiment, the impact measurement data may be analyzed (e.g., via AI and/or ML) to improve effectiveness of policy enforcement rules (e.g., to improve selection of effective enforcement protocols and/or associated enforcement protocol severity levels). In one implementation, an AI and/or ML component (e.g., implemented via scikit-learn) may be utilized to train (e.g., via Reinforcement Learning) an AI and/or ML model (e.g., a Neural Network, large language model, and/or the like) via the impact measurement data (e.g., using activity category, user characteristics (e.g., age, utilized device type, and/or the like), previously utilized enforcement protocols and/or associated severity levels, and/or the like as a state, available enforcement protocols and/or associated severity levels as actions, and a reward function that rewards superior effectiveness measures (e.g., smaller number of minutes and/or disturbance intervals until a user stops an internet-based activity)) to predict one or more effective sets of enforcement protocols and/or associated severity levels to utilize during a disturb period.

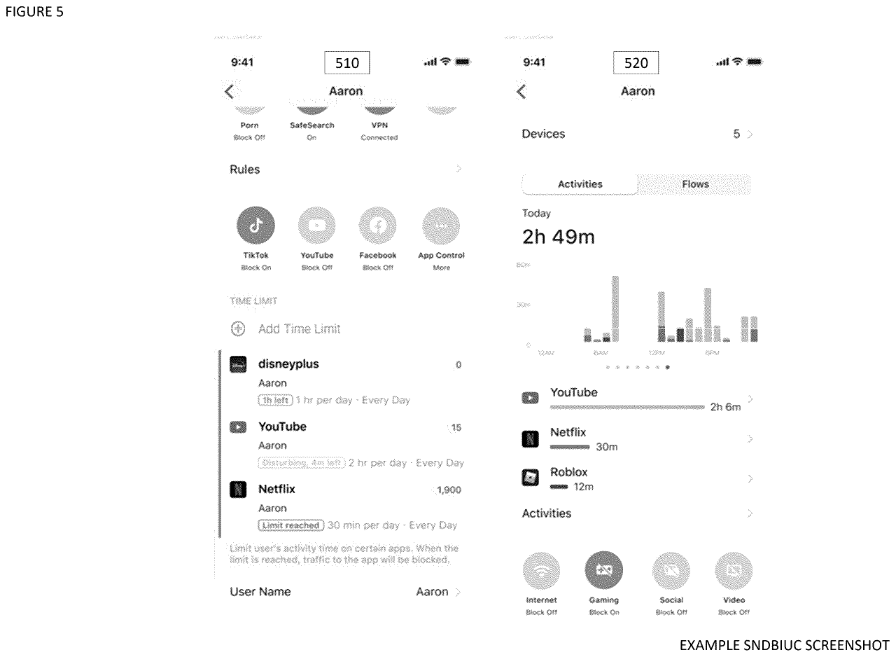

FIG. 5 shows an example of screenshot diagram(s) in one embodiment of the SNDBIUC. In FIG. 5, an example user interface (e.g., for a mobile device, for a website, and/or the like) for providing impact measurement data analysis results is illustrated. Screen 510 shows that a network usage policy rule allows a user (e.g., Aaron) to use YouTube® for two hours per day. The user exceeded the allowed policy time limit for YouTube© and there are four minutes of disturb period left (e.g., out of 10 minutes) before YouTube® is blocked completely for the day. Screen 520 shows that the user used YouTube® for two hours and six minutes during the day, of which six minutes (e.g., shown in yellow) are time over the policy time limit during which simulated network disruptions were utilized to encourage the user to stop watching YouTube®.

### DETAILED DESCRIPTION OF THE SNDBIUC COORDINATOR

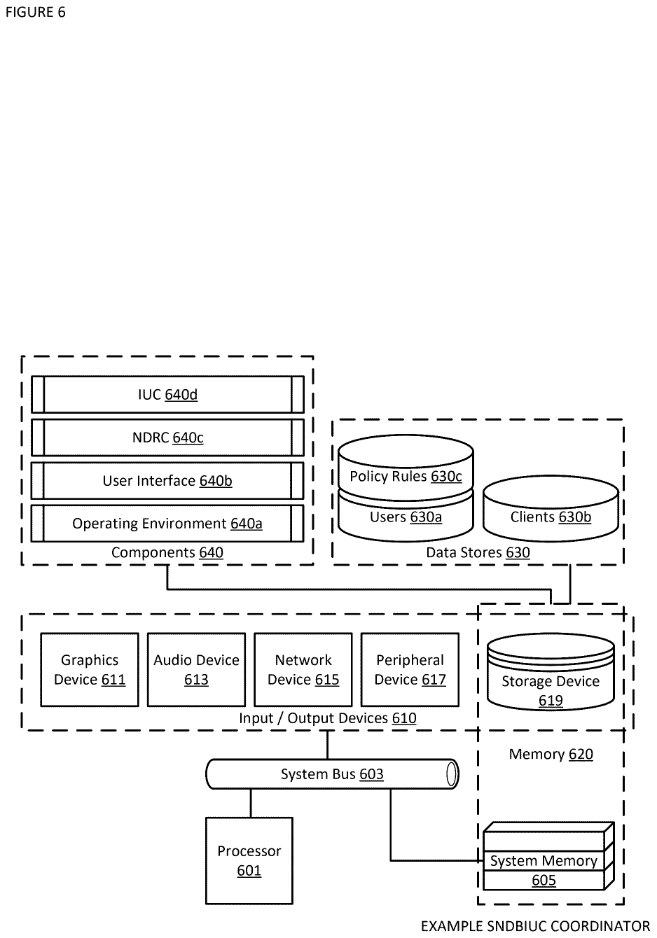

FIG. 6 shows a block diagram illustrating an example SNDBIUC coordinator in one embodiment of the SNDBIUC. The SNDBIUC coordinator facilitates the operation of the SNDBIUC via a computer system (e.g., one or more cloud computing systems (e.g., Microsoft Azure, Amazon Web Services, Google Cloud Platform), grid computing systems, virtualized computer systems, mainframe computers, servers, clients, nodes, desktops, mobile devices (e.g., such as smart phones, cellular phones, tablets, personal digital assistants (PDAs), smart watches, and/or the like), embedded computers, dedicated computers, system on a chip (SOC) devices, and/or the like). For example, the SNDBIUC coordinator may receive, obtain, aggregate, process, generate, store, retrieve, send, delete, input, output, and/or the like data (including program data and program instructions); may execute program instructions; may communicate with computer systems, with nodes, with users, and/or the like. In various embodiments, the SNDBIUC coordinator may comprise a standalone computer system, a distributed computer system, a node in a computer network (i.e., a network of computer systems organized in a topology), a network of SNDBIUC coordinators, and/or the like. It is to be understood that the SNDBIUC coordinator and/or the various SNDBIUC coordinator elements (e.g., processor, system bus, memory, input/output devices) may be organized in any number of ways (i.e., using any number and configuration of computer systems, computer networks, nodes, SNDBIUC coordinator elements, and/or the like) to facilitate SNDBIUC operation. Furthermore, it is to be understood that the various SNDBIUC coordinator computer systems, SNDBIUC coordinator computer networks, SNDBIUC coordinator nodes, SNDBIUC coordinator elements, and/or the like may communicate among each other in any number of ways to facilitate SNDBIUC operation. As used in this disclosure, the term “user” refers generally to people and/or computer systems that interact with the SNDBIUC; the term “server” refers generally to a computer system, a program, and/or a combination thereof that handles requests and/or responds to requests from clients via a computer network; the term “client” refers generally to a computer system, a program, a user, and/or a combination thereof that generates requests and/or handles responses from servers via a computer network; the term “node” refers generally to a server, to a client, and/or to an intermediary computer system, program, and/or a combination thereof that facilitates transmission of and/or handling of requests and/or responses.

The SNDBIUC coordinator includes a processor 601 that executes program instructions (e.g., SNDBIUC program instructions). In various embodiments, the processor may be a general purpose microprocessor (e.g., a central processing unit (CPU), an accelerated processing unit (APU)), a dedicated microprocessor (e.g., a graphics processing unit (GPU), a physics processing unit (PPU), a digital signal processor (DSP), a network processor, a tensor processing unit (TPU), a cryptographic processor, a biometrics processor, and/or the like), an external processor, a plurality of processors (e.g., working in parallel, distributed, and/or the like), a microcontroller (e.g., for an embedded system), and/or the like. The processor may be implemented using integrated circuits (ICs), application-specific integrated circuits (ASICs), field-programmable gate arrays (FPGAs), and/or the like. In various implementations, the processor may comprise one or more cores, may include embedded elements (e.g., a coprocessor such as a math coprocessor, an embedded dedicated microprocessor utilized as a coprocessor, registers, cache memory, software), may be synchronous (e.g., using a clock signal) or asynchronous (e.g., without a central clock), and/or the like. For example, the processor may be an AMD Ryzen processor, an AMD Epyc processor, an Intel Core processor, an Intel Xeon processor, an ARM Cortex processor, an Apple A processor, an Apple S processor, a Qualcomm Snapdragon processor, an IBM PowerPC processor, and/or the like.

The processor may be connected to system memory 605 via a system bus 603. The system bus may interconnect these and/or other elements of the SNDBIUC coordinator via electrical, electronic, optical, wireless, and/or the like communication links (e.g., the system bus may be integrated into a motherboard that interconnects SNDBIUC coordinator elements and provides power from a power supply). In various embodiments, the system bus may comprise one or more control buses, address buses, data buses, memory buses, peripheral buses, and/or the like. In various implementations, the system bus may be a parallel bus, a serial bus, a daisy chain design, a hub design, and/or the like. For example, the system bus may comprise a front-side bus, a back-side bus, AMD's Infinity Fabric, Intel's QuickPath Interconnect (QPI), a peripheral component interconnect (PCI) bus, a PCI Express bus, a low pin count (LPC) bus, a universal serial bus (USB), and/or the like. The system memory, in various embodiments, may comprise registers, cache memory (e.g., level one, level two, level three), volatile memory (e.g., random access memory (RAM) (e.g., static RAM (SRAM), dynamic RAM (DRAM)), non-volatile memory (e.g., read only memory (ROM), non-volatile random-access memory (NVRAM) (e.g., resistive random access memory (ReRAM), magnetoresistive random access memory (MRAM)), flash memory (e.g., NAND-type)), and/or the like. The system memory may utilize error-correcting code (ECC) technology to detect and/or correct internal data corruption. The system memory may be discreet, external, embedded, integrated into a CPU, and/or the like. The processor may access, read from, write to, store in, erase, modify, and/or the like, the system memory in accordance with program instructions (e.g., SNDBIUC program instructions) executed by the processor. The system memory may facilitate accessing, storing, retrieving, modifying, deleting, and/or the like data (e.g., SNDBIUC data) by the processor.

In various embodiments, input/output devices 610 may be connected to the processor and/or to the system memory, and/or to one another via the system bus.

In some embodiments, the input/output devices may include one or more graphics devices 611. The processor may make use of the one or more graphic devices in accordance with program instructions (e.g., SNDBIUC program instructions) executed by the processor. In one implementation, a graphics device may be a video card that may obtain (e.g., via a connected video camera), process (e.g., render a frame), output (e.g., via a connected monitor, television, and/or the like), and/or the like graphical (e.g., multimedia, video, image, text) data (e.g., SNDBIUC data). A video card may be connected to the system bus via an interface such as PCI, PCI Express, USB, PC Card, ExpressCard, Thunderbolt, NVLink, and/or the like. A video card may use one or more graphics processing units (GPUs), for example, by utilizing AMD's CrossFireX and/or NVIDIA's SLI technologies. A video card may be connected via an interface (e.g., video graphics array (VGA), digital video interface (DVI), Mini-DVI, Micro-DVI, high-definition multimedia interface (HDMI), DisplayPort, Thunderbolt, composite video, S-Video, component video, and/or the like) to one or more displays (e.g., cathode ray tube (CRT), liquid crystal display (LCD), touchscreen, video projector, and/or the like) that display graphics. For example, a video card may be an AMD Radeon, an NVIDIA GeForce RTX, an Intel UHD Graphics, and/or the like. In another implementation, a graphics device may be a video capture board that may obtain (e.g., via coaxial cable), process (e.g., overlay with other graphical data), capture, convert (e.g., between different formats, such as MPEG2 to H.264), and/or the like graphical data. A video capture board may be and/or include a TV tuner, may be compatible with a variety of broadcast signals (e.g., NTSC, PAL, ATSC, QAM) may be a part of a video card, and/or the like. For example, a video capture board may be a Hauppauge ImpactVCB, a Hauppauge WinTV-HVR, a Hauppauge Colossus, and/or the like. A graphics device may be discreet, external, embedded, integrated into a CPU, and/or the like. A graphics device may operate in combination with other graphics devices (e.g., in parallel) to provide improved capabilities, data throughput, color depth, and/or the like.

In some embodiments, the input/output devices may include one or more audio devices 613. The processor may make use of the one or more audio devices in accordance with program instructions (e.g., SNDBIUC program instructions) executed by the processor. In one implementation, an audio device may be a sound card that may obtain (e.g., via a connected microphone), process, output (e.g., via connected speakers), and/or the like audio data (e.g., SNDBIUC data). A sound card may be connected to the system bus via an interface such as PCI, PCI Express, USB, PC Card, ExpressCard, Thunderbolt, and/or the like. A sound card may be connected via an interface (e.g., tip sleeve (TS), tip ring sleeve (TRS), RCA, TOSLINK, optical) to one or more amplifiers, speakers (e.g., mono, stereo, surround sound), subwoofers, digital musical instruments, and/or the like. For example, a sound card may be an Intel AC'97 integrated codec chip, an Intel HD Audio integrated codec chip, a Creative Sound Blaster, and/or the like. An audio device may be discreet, external, embedded, integrated into a motherboard (e.g., via a chipset), and/or the like. An audio device may operate in combination with other audio devices (e.g., in parallel) to provide improved capabilities, data throughput, audio quality, and/or the like.

In some embodiments, the input/output devices may include one or more network devices 615. The processor may make use of the one or more network devices in accordance with program instructions (e.g., SNDBIUC program instructions) executed by the processor. In one implementation, a network device may be a network card that may obtain (e.g., via a Category 6 Ethernet cable), process, output (e.g., via a wireless antenna), and/or the like network data (e.g., SNDBIUC data). A network card may be connected to the system bus via an interface such as PCI, PCI Express, USB, FireWire, PC Card, ExpressCard, Thunderbolt, and/or the like. A network card may be a wired network card (e.g., 10/100/1000BASE-T, optical fiber), a wireless network card (e.g., Wi-Fi 802.11ac/ad/ax/ay, Bluetooth, Near Field Communication (NFC), TransferJet), a modem (e.g., dialup telephone-based, asymmetric digital subscriber line (ADSL), cable modem, power line modem, wireless modem based on cellular protocols such as high speed packet access (HSPA), evolution-data optimized (EV-DO), global system for mobile communications (GSM), worldwide interoperability for microwave access (WiMax), long term evolution (LTE), 5G, and/or the like, satellite modem, FM radio modem, radio-frequency identification (RFID) modem, infrared (IR) modem), and/or the like. For example, a network card may be an Intel Gigabit Adapter, a LINKSYS USB Ethernet Adapter, an ASUS wireless Bluetooth and Gigabit Wi-Fi adapter, a Motorola SURFboard Cable Modem, a U.S. Robotics Faxmodem, a Zoom ADSL Modem/Router, a TRENDnet Powerline Ethernet Adapter, a StarTech Gigabit Ethernet Multi Mode Fiber Media Converter, a Broadcom NFC controller, a Qualcomm Snapdragon 4G LTE and 5G modem, a Toshiba TransferJet device, and/or the like. A network device may be discreet, external, embedded, integrated into a motherboard, and/or the like. A network device may operate in combination with other network devices (e.g., in parallel) to provide improved data throughput, redundancy, and/or the like. For example, protocols such as link aggregation control protocol (LACP) (e.g., based on IEEE 802.3AD or IEEE 802.1AX standards) may be used. A network device may be used to connect to a local area network (LAN), a wide area network (WAN), a metropolitan area network (MAN), a personal area network, the Internet, an intranet, a Bluetooth network, an NFC network, a Wi-Fi network, a cellular network, and/or the like.

In some embodiments, the input/output devices may include one or more peripheral devices 617. The processor may make use of the one or more peripheral devices in accordance with program instructions (e.g., SNDBIUC program instructions) executed by the processor. In various implementations, a peripheral device may be a digital camera, a video camera, a webcam, an electronically moveable pan tilt zoom (PTZ) camera, a monitor, a touchscreen display, active shutter 3D glasses, head-tracking 3D glasses, a virtual reality (VR) headset, an augmented reality (AR) headset, a remote control, an audio line-in, an audio line-out, a microphone, headphones, speakers, a subwoofer, an amplifier, a router, a hub, a switch, a firewall, an antenna, a keyboard, a mouse, a trackpad, a trackball, a digitizing tablet, a stylus, a joystick, a gamepad, a game controller, a force-feedback device, a laser, sensors (e.g., proximity sensor, rangefinder, ambient temperature sensor, ambient light sensor, humidity sensor, an accelerometer, a gyroscope, a motion sensor, an olfaction sensor, a biosensor, a biometric sensor, a chemical sensor, a magnetometer, a radar, a sonar, a location sensor such as global positioning system (GPS), Galileo, GLONASS, and/or the like), a printer, a fax, a scanner, a copier, a card reader, a fingerprint reader, a pin entry device (PED), a Trusted Platform Module (TPM), a hardware security module (HSM), and/or the like. A peripheral device may be connected to the system bus via an interface such as PCI, PCI Express, USB, FireWire, VGA, DVI, Mini-DVI, Micro-DVI, HDMI, DisplayPort, Thunderbolt, composite video, S-Video, component video, PC Card, ExpressCard, serial port, parallel port, PS/2, TS, TRS, RCA, TOSLINK, network connection (e.g., wired such as Ethernet, optical fiber, and/or the like; wireless such as Wi-Fi, Bluetooth, NFC, cellular, 5G, and/or the like), a connector of another input/output device, and/or the like. A peripheral device may be discreet, external, embedded, integrated (e.g., into a processor, into a motherboard), and/or the like. A peripheral device may operate in combination with other peripheral devices (e.g., in parallel) to provide the SNDBIUC coordinator with a variety of input, output and processing capabilities.

In some embodiments, the input/output devices may include one or more storage devices 619. The processor may access, read from, write to, store in, erase, modify, and/or the like a storage device in accordance with program instructions (e.g., SNDBIUC program instructions) executed by the processor. A storage device may facilitate accessing, storing, retrieving, modifying, deleting, and/or the like data (e.g., SNDBIUC data) by the processor. In one implementation, the processor may access data from the storage device directly via the system bus. In another implementation, the processor may access data from the storage device by instructing the storage device to transfer the data to the system memory and accessing the data from the system memory. In various embodiments, a storage device may be a hard disk drive (HDD), a solid-state drive (SSD), an optical disk drive (e.g., compact disk (CD-ROM) drive, CD-Recordable (CD-R) drive, CD-Rewriteable (CD-RW) drive, digital versatile disc (DVD-ROM) drive, DVD-R drive, DVD-RW drive, Blu-ray disk (BD) drive) using an optical medium, a magnetic tape drive using a magnetic tape, a memory card (e.g., a USB flash drive, a compact flash (CF) card, a secure digital extended capacity (SDXC) card), a network attached storage (NAS), a direct-attached storage (DAS), a storage area network (SAN), other processor-readable physical mediums, and/or the like. A storage device may be connected to the system bus via an interface such as PCI, PCI Express, USB, FireWire, PC Card, ExpressCard, Thunderbolt, integrated drive electronics (IDE), serial advanced technology attachment (SATA), non-volatile memory express (NVMe), external SATA (eSATA), small computer system interface (SCSI), serial attached SCSI (SAS), fibre channel (FC), network connection (e.g., wired such as Ethernet, optical fiber, and/or the like; wireless such as Wi-Fi, Bluetooth, NFC, cellular, 5G, and/or the like), and/or the like. A storage device may be discreet, external, embedded, integrated (e.g., into a motherboard, into another storage device), and/or the like. A storage device may operate in combination with other storage devices to provide improved capacity, data throughput, data redundancy, and/or the like. For example, protocols such as redundant array of independent disks (RAID) (e.g., RAID 0 (striping), RAID 1 (mirroring), RAID 5 (striping with distributed parity), hybrid RAID), just a bunch of drives (JBOD), and/or the like may be used. In another example, virtual and/or physical drives may be pooled to create a storage pool (e.g., for virtual storage, cloud storage, and/or the like). In yet another example, an SSD cache may be used with an HDD to improve speed.

Together and/or separately the system memory 605 and the one or more storage devices 619 may be referred to as memory 620 (i.e., physical memory).

SNDBIUC memory 620 contains processor-operable (e.g., accessible) SNDBIUC data stores 630. Data stores 630 comprise data that may be used (e.g., by the SNDBIUC) via the SNDBIUC coordinator. Such data may be organized using one or more data formats such as a database (e.g., a relational database with database tables, an object-oriented database, a graph database, a hierarchical database, a key-value NoSQL database), a flat file (e.g., organized into a tabular format), a binary file (e.g., a GIF file, an MPEG-4 file), a structured file (e.g., an HTML file, an XML file), a text file, and/or the like. Furthermore, data may be organized using one or more data structures such as an array, a queue, a stack, a set, a linked list, a map, a tree, a hash table, a record, an object, a directed graph, and/or the like. In various embodiments, data stores may be organized in any number of ways (i.e., using any number and configuration of data formats, data structures, SNDBIUC coordinator elements, and/or the like) to facilitate SNDBIUC operation. For example, SNDBIUC data stores may comprise data stores 630a-c implemented as one or more databases. A users data store 630a may be a collection of database tables that include fields such as UserID, UserName, UserPreferences, UserAssociatedUserGroupIDs, UserAssociatedClientIDs, UserRules, and/or the like. A clients data store 630b may be a collection of database tables that include fields such as ClientID, ClientName, ClientDeviceType, ClientScreenResolution, ClientIP_Address, Client_MAC_Address, ClientRules, and/or the like. A policy rules data store 630c may be a collection of database tables that include fields such as PolicyRuleID, PolicyRuleName, PolicyRuleAffectedUserGroupIDs, PolicyRuleAffectedUserIDs, PolicyRuleAffectedClientIDs, PolicyRuleAffectedDeviceIDs, PolicyRuleAffectedIP_Addresses, PolicyRuleAffectedMAC_Addresses, PolicyRuleMatchingActivityTypes (e.g., activity types, applications, websites, etc.), PolicyRuleTimeLimit, PolicyRuleEnforcementProtocolsType, PolicyRuleEnforcementProtocolsDetails, PolicyRuleDisturbPeriod, PolicyRulelmpactMeasurementData, and/or the like. The SNDBIUC coordinator may use data stores 630 to keep track of inputs, parameters, settings, variables, records, outputs, and/or the like.

SNDBIUC memory 620 contains processor-operable (e.g., executable) SNDBIUC components 640. Components 640 comprise program components (including program instructions and any associated data stores) that are executed (e.g., by the SNDBIUC) via the SNDBIUC coordinator (i.e., via the processor) to transform SNDBIUC inputs into SNDBIUC outputs. It is to be understood that the various components and their subcomponents, capabilities, applications, and/or the like may be organized in any number of ways (i.e., using any number and configuration of components, subcomponents, capabilities, applications, SNDBIUC coordinator elements, and/or the like) to facilitate SNDBIUC operation. Furthermore, it is to be understood that the various components and their subcomponents, capabilities, applications, and/or the like may communicate among each other in any number of ways to facilitate SNDBIUC operation. For example, the various components and their subcomponents, capabilities, applications, and/or the like may be combined, integrated, consolidated, split up, distributed, and/or the like in any number of ways to facilitate SNDBIUC operation. In another example, a single or multiple instances of the various components and their subcomponents, capabilities, applications, and/or the like may be instantiated on each of a single SNDBIUC coordinator node, across multiple SNDBIUC coordinator nodes, and/or the like.

In various embodiments, program components may be developed using one or more programming languages, techniques, tools, and/or the like such as an assembly language, Ada, BASIC, C, C++, C#, COBOL, Fortran, Java, LabVIEW, Lisp, Mathematica, MATLAB, OCaml, PL/I, Smalltalk, Solidity, Visual Basic for Applications (VBA), HTML, XML, CSS, JavaScript, JavaScript Object Notation (JSON), PHP, Perl, Ruby, Python, Asynchronous JavaScript and XML (AJAX), WebSocket Protocol, Simple Object Access Protocol (SOAP), SSL, ColdFusion, Microsoft .NET, Apache modules, Adobe Flash, Adobe AIR, Microsoft Silverlight, Windows PowerShell, batch files, Tcl, graphical user interface (GUI) toolkits, SQL, database adapters, web application programming interfaces (APIs), web frameworks (e.g., Ruby on Rails, AngularJS), application server extensions, integrated development environments (IDEs), libraries (e.g., object libraries, class libraries, remote libraries), remote procedure calls (RPCs), Common Object Request Broker Architecture (CORBA), and/or the like.

In some embodiments, components 640 may include an operating environment component 640a. The operating environment component may facilitate operation of the SNDBIUC via various subcomponents.

In some implementations, the operating environment component may include an operating system subcomponent. The operating system subcomponent may provide an abstraction layer that facilitates the use of, communication among, common services for, interaction with, security of, and/or the like of various SNDBIUC coordinator elements, components, data stores, and/or the like.

In some embodiments, the operating system subcomponent may facilitate execution of program instructions (e.g., SNDBIUC program instructions) by the processor by providing process management capabilities. For example, the operating system subcomponent may facilitate the use of multiple processors, the execution of multiple processes, the execution of multiple threads, multitasking, and/or the like.

In some embodiments, the operating system subcomponent may facilitate the use of memory by the SNDBIUC. For example, the operating system subcomponent may allocate and/or free memory, facilitate memory addressing, provide memory segmentation and/or protection, provide virtual memory capability, facilitate caching, and/or the like. In another example, the operating system subcomponent may include a file system (e.g., File Allocation Table (FAT), New Technology File System (NTFS), Hierarchical File System Plus (HFS+), Apple File System (APFS), Universal Disk Format (UDF), Linear Tape File System (LTFS)) to facilitate storage, retrieval, deletion, aggregation, processing, generation, and/or the like of data.

In some embodiments, the operating system subcomponent may facilitate operation of and/or processing of data for and/or from input/output devices. For example, the operating system subcomponent may include one or more device drivers, interrupt handlers, file systems, and/or the like that allow interaction with input/output devices.

In some embodiments, the operating system subcomponent may facilitate operation of the SNDBIUC coordinator as a node in a computer network by providing support for one or more communications protocols. For example, the operating system subcomponent may include support for the internet protocol suite (i.e., Transmission Control Protocol/Internet Protocol (TCP/IP)) of network protocols such as IP, IPsec, Mobile IP, TCP, User Datagram Protocol (UDP), and/or the like. In another example, the operating system subcomponent may include support for security protocols (e.g., Wired Equivalent Privacy (WEP), Wi-Fi Protected Access (WPA), WPA2, WPA3) for wireless computer networks. In yet another example, the operating system subcomponent may include support for virtual private networks (VPNs).

In some embodiments, the operating system subcomponent may facilitate security of the SNDBIUC coordinator. For example, the operating system subcomponent may provide services such as authentication, authorization, audit, network intrusion-detection capabilities, firewall capabilities, antivirus capabilities, and/or the like.

In some embodiments, the operating system subcomponent may facilitate user interaction with the SNDBIUC by providing user interface elements that may be used by the SNDBIUC to generate a user interface. In one implementation, such user interface elements may include widgets (e.g., windows, dialog boxes, scrollbars, menu bars, tabs, ribbons, menus, buttons, text boxes, checkboxes, combo boxes, drop-down lists, list boxes, radio buttons, sliders, spinners, grids, labels, progress indicators, icons, tooltips, and/or the like) that may be used to obtain input from and/or provide output to the user. For example, such widgets may be used via a widget toolkit such as Microsoft Foundation Classes (MFC), Apple Cocoa Touch, Java Swing, JavaFX, jQuery UI, GTK, Qt, and/or the like. In another implementation, such user interface elements may include sounds (e.g., event notification sounds stored in MP3 file format), animations, vibrations, and/or the like that may be used to inform the user regarding occurrence of various events. For example, the operating system subcomponent may include a user interface such as Windows Aero, Windows Metro, macOS X Aqua, macOS X Flat, GNOME Shell, KDE Plasma Workspaces (e.g., Plasma Desktop, Plasma Netbook, Plasma Contour, Plasma Mobile), and/or the like.

In various embodiments the operating system subcomponent may comprise a single-user operating system, a multi-user operating system, a single-tasking operating system, a multitasking operating system, a single-processor operating system, a multiprocessor operating system, a distributed operating system, an embedded operating system, a real-time operating system, and/or the like. For example, the operating system subcomponent may comprise an operating system such as UNIX, LINUX, IBM i, Sun Solaris, Microsoft Windows Server, Microsoft DOS, Microsoft Windows 11, Apple Mac OS X, Apple iOS, Google Android, and/or the like.

In some implementations, the operating environment component may include a database subcomponent. The database subcomponent may facilitate SNDBIUC capabilities such as storage, analysis, retrieval, access, modification, deletion, aggregation, generation, and/or the like of data (e.g., the use of data stores 630). The database subcomponent may make use of database languages (e.g., Structured Query Language (SQL), XQuery, Cassandra Query Language (CQL)), stored procedures, triggers, APIs, and/or the like to provide these capabilities. In various embodiments the database subcomponent may comprise a cloud database, a data warehouse, a distributed database, an embedded database, a parallel database, a real-time database, and/or the like. For example, the database subcomponent may comprise a database such as Microsoft SQL Server, Microsoft Access, MySQL, IBM DB2, Oracle Database, Apache Cassandra database, MongoDB, and/or the like.

In some implementations, the operating environment component may include an information handling subcomponent. The information handling subcomponent may provide the SNDBIUC with capabilities to serve, deliver, upload, obtain, present, download, and/or the like a variety of information. The information handling subcomponent may use protocols such as Hypertext Transfer Protocol (HTTP), Hypertext Transfer Protocol Secure (HTTPS), File Transfer Protocol (FTP), Telnet, Secure Shell (SSH), Transport Layer Security (TLS), Secure Sockets Layer (SSL), peer-to-peer (P2P) protocols (e.g., BitTorrent, Bitcoin), and/or the like to handle communication of information such as web pages, files, multimedia content (e.g., streaming media), applications, transactions, and/or the like.

In some embodiments, the information handling subcomponent may facilitate the serving of information to users, SNDBIUC components, nodes in a computer network, web browsers, and/or the like. For example, the information handling subcomponent may comprise a web server such as Apache HTTP Server, Microsoft Internet Information Services (IIS), Oracle WebLogic Server, Adobe Flash Media Server, Adobe Content Server, and/or the like. Furthermore, a web server may include extensions, plug-ins, add-ons, servlets, and/or the like. For example, these may include Apache modules, IIS extensions, Java servlets, and/or the like. In some implementations, the information handling subcomponent may communicate with the database subcomponent via standards such as Open Database Connectivity (ODBC), Java Database Connectivity (JDBC), ActiveX Data Objects for .NET (ADO.NET), and/or the like. For example, the information handling subcomponent may use such standards to store, analyze, retrieve, access, modify, delete, aggregate, generate, and/or the like data (e.g., data from data stores 630) via the database subcomponent.

In some embodiments, the information handling subcomponent may facilitate presentation of information obtained from users, SNDBIUC components, nodes in a computer network, web servers, and/or the like. For example, the information handling subcomponent may comprise a web browser such as Microsoft Internet Explorer, Microsoft Edge, Mozilla Firefox, Apple Safari, Google Chrome, Opera Mobile, Amazon Silk, Nintendo 3DS Internet Browser, and/or the like. Furthermore, a web browser may include extensions, plug-ins, add-ons, applets, and/or the like. For example, these may include Adobe Flash Player, Adobe Acrobat plug-in, Microsoft Silverlight plug-in, Microsoft Office plug-in, Java plug-in, and/or the like.

In some implementations, the operating environment component may include a messaging subcomponent. The messaging subcomponent may facilitate SNDBIUC message communications capabilities. The messaging subcomponent may use protocols such as Simple Mail Transfer Protocol (SMTP), Internet Message Access Protocol (IMAP), Post Office Protocol (POP), Extensible Messaging and Presence Protocol (XMPP), Real-time Transport Protocol (RTP), Internet Relay Chat (IRC), Skype protocol, Messaging Application Programming Interface (MAPI), Facebook API, a custom protocol, and/or the like to facilitate SNDBIUC message communications. The messaging subcomponent may facilitate message communications such as email, instant messaging, Voice over IP (VoIP), video conferencing, Short Message Service (SMS), web chat, in-app messaging (e.g., alerts, notifications), and/or the like. For example, the messaging subcomponent may comprise Microsoft Exchange Server, Microsoft Outlook, Sendmail, IBM Domino, IBM Notes, Gmail, ICQ, Trillian, Skype, Google Hangouts, Apple FaceTime, Apple iChat, Facebook Chat, and/or the like.

In some implementations, the operating environment component may include a security subcomponent that facilitates SNDBIUC security. In some embodiments, the security subcomponent may restrict access to the SNDBIUC, to one or more services provided by the SNDBIUC, to data associated with the SNDBIUC (e.g., stored in data stores 630), to communication messages associated with the SNDBIUC, and/or the like to authorized users. Access may be granted via a login screen, via an API that obtains authentication information, via an authentication token, via a cryptographic key (e.g., stored in an HSM), and/or the like. For example, the user may obtain access by providing a username and/or a password (e.g., a string of characters, a picture password), a personal identification number (PIN), an identification card, a magnetic stripe card, a smart card, a biometric identifier (e.g., a finger print, a voice print, a retina scan, a face scan), a gesture (e.g., a swipe), a media access control (MAC) address, an IP address, and/or the like. Various security models such as access-control lists (ACLs), capability-based security, hierarchical protection domains, multi-factor authentication, and/or the like may be used to control access. For example, the security subcomponent may facilitate digital rights management (DRM), network intrusion detection, firewall capabilities, cryptographic wallet access (e.g., for cryptocurrencies such as Bitcoin, Ethereum, and/or the like), and/or the like.

In some embodiments, the security subcomponent may use cryptographic techniques to secure information (e.g., by storing encrypted data), verify message authentication (e.g., via a digital signature), provide integrity checking (e.g., a checksum), authorize transactions (e.g., using a private key), and/or the like by facilitating encryption and/or decryption of data. Furthermore, steganographic techniques may be used instead of or in combination with cryptographic techniques. Cryptographic techniques used by the SNDBIUC may include symmetric key cryptography using shared keys (e.g., using one or more block ciphers such as triple Data Encryption Standard (DES), Advanced Encryption Standard (AES); stream ciphers such as Rivest Cipher 4 (RC4), Rabbit), asymmetric key cryptography using a public key/private key pair (e.g., using algorithms such as Rivest-Shamir-Adleman (RSA), Elliptic Curve Digital Signature Algorithm (ECDSA)), cryptographic hash functions (e.g., using algorithms such as Message-Digest 5 (MD5), Secure Hash Algorithm 3 (SHA-3)), and/or the like. For example, the security subcomponent may comprise a cryptographic system such as Pretty Good Privacy (PGP).

In some implementations, the operating environment component may include a virtualization subcomponent that facilitates SNDBIUC virtualization capabilities. The virtualization subcomponent may include hypervisors (e.g., Type-1 native hypervisors, Type-2 hosted hypervisors), virtual machines (VMs), and/or the like. In some embodiments, the virtualization subcomponent may provide support for platform virtualization (e.g., via a virtual machine). Platform virtualization types may include full virtualization, partial virtualization, paravirtualization, and/or the like. In some implementations, platform virtualization may be hardware-assisted (e.g., via support from the processor using technologies such as AMD-V, Intel VT-x, and/or the like). In some embodiments, the virtualization subcomponent may provide support for various other virtualized environments such as via operating-system level virtualization, desktop virtualization, workspace virtualization, mobile virtualization, application virtualization, database virtualization, and/or the like. In some embodiments, the virtualization subcomponent may provide support for various virtualized resources such as via processing resources virtualization, memory virtualization, storage virtualization, data virtualization, network virtualization, and/or the like. For example, the virtualization subcomponent may comprise VMware software suite (e.g., VMware Workstation, VMware Player, VMware ESXi, VMware ThinApp, VMware Infrastructure), Parallels software suite (e.g., Parallels Server, Parallels Desktop), Virtuozzo software suite (e.g., Virtuozzo Infrastructure Platform, Virtuozzo), Oracle software suite (e.g., Oracle VM Server for SPARC, Oracle VM Server for x86, Oracle VM VirtualBox, Oracle Solaris 11), Wine, and/or the like.

In some embodiments, components 640 may include a user interface component 640b. The user interface component may facilitate user interaction with the SNDBIUC by providing a user interface. In various implementations, the user interface component may include programmatic instructions to obtain input from and/or provide output to the uservia physical controls (e.g., physical buttons, switches, knobs, wheels, dials), textual user interface, audio user interface, GUI, voice recognition, gesture recognition, touch and/or multi-touch user interface, messages, APIs, and/or the like. In some implementations, the user interface component may make use of the user interface elements provided by the operating system subcomponent of the operating environment component. For example, the user interface component may make use of the operating system subcomponent's user interface elements via a widget toolkit. In some implementations, the user interface component may make use of information presentation capabilities provided by the information handling subcomponent of the operating environment component. For example, the user interface component may make use of a web browser to provide a user interface via HTML5, Adobe Flash, Microsoft Silverlight, and/or the like.

In some embodiments, components 640 may include any of the components NDRC 640c, IUC 640d, etc. described in more detail in preceding figures and/or in appendices.

### The Embodiments of the SNDBIUC

The entirety of this disclosure (including the written description, figures, claims, abstract, appendices, and/or the like) for SIMULATED NETWORK DISRUPTION BASED INTERNET USAGE CONTROLLER APPARATUSES, METHODS, SYSTEMS AND MEDIA shows various embodiments via which the claimed innovations may be practiced. It is to be understood that these embodiments and the features they describe are a representative sample presented to assist in understanding the claimed innovations, and are not exhaustive and/or exclusive. As such, the various embodiments, implementations, examples, and/or the like are deemed non-limiting throughout this disclosure. Furthermore, alternate undescribed embodiments may be available (e.g., equivalent embodiments). Such alternate embodiments have not been discussed in detail to preserve space and/or reduce repetition. That alternate embodiments have not been discussed in detail is not to be considered a disclaimer of such alternate undescribed embodiments, and no inference should be drawn regarding such alternate undescribed embodiments relative to those discussed in detail in this disclosure. It is to be understood that such alternate undescribed embodiments may be utilized without departing from the spirit and/or scope of the disclosure. For example, the organizational, logical, physical, functional, topological, and/or the like structures of various embodiments may differ. In another example, the organizational, logical, physical, functional, topological, and/or the like structures of the SNDBIUC coordinator, SNDBIUC coordinator elements, SNDBIUC data stores, SNDBIUC components and their subcomponents, capabilities, applications, and/or the like described in various embodiments throughout this disclosure are not limited to a fixed operating order and/or arrangement, instead, all equivalent operating orders and/or arrangements are contemplated by this disclosure. In yet another example, the SNDBIUC coordinator, SNDBIUC coordinator elements, SNDBIUC data stores, SNDBIUC components and their subcomponents, capabilities, applications, and/or the like described in various embodiments throughout this disclosure are not limited to serial execution, instead, any number and/or configuration of threads, processes, instances, services, servers, clients, nodes, virtual machines, and/or the like that execute in parallel, concurrently, simultaneously, synchronously, asynchronously, and/or the like is contemplated by this disclosure. Furthermore, it is to be understood that some of the features described in this disclosure may be mutually contradictory, incompatible, inapplicable, and/or the like, and are not present simultaneously in the same embodiment. Accordingly, the various embodiments, implementations, examples, and/or the like are not to be considered limitations on the disclosure as defined by the claims or limitations on equivalents to the claims.

This disclosure includes innovations not currently claimed. Applicant reserves all rights in such currently unclaimed innovations including the rights to claim such innovations and to file additional provisional applications, nonprovisional applications, continuation applications, continuation-in-part applications, divisional applications, and/or the like. It is to be understood that while some embodiments of the SNDBIUC discussed in this disclosure have been directed to controlling children's internet access, the innovations described in this disclosure may be readily applied to a wide variety of other fields and/or applications.

The following is claimed:

1. An apparatus, comprising:
at least one memory;
at least one processor in communication with the at least one memory, the at least one processor configured to execute processing instructions stored in the at least one memory, in which the at least one processor executes processor-executable instructions to:
obtain, via the at least one processor, a network request data structure comprising a source network interface address, a destination network interface address, and activity content;
determine, via the at least one processor, a device associated with the network request data structure based on the source network interface address;
determine, via the at least one processor, an activity category associated with the network request data structure based on the destination network interface address;
determine, via the at least one processor, a network usage policy rule data structure associated with the device and applicable to the activity category;
determine, via the at least one processor, a policy rule time limit specified via the network usage policy rule data structure;
determine, via the at least one processor, that the policy rule time limit has been exceeded;
determine, via the at least one processor, a disturb period specified via the network usage policy rule data structure;
determine, via the at least one processor, that the disturb period has not been exceeded;
determine, via the at least one processor, an enforcement protocol specified via the policy rule data structure to utilize for the activity category; and
apply, via the at least one processor, the enforcement protocol to the network request data structure to simulate a network disruption.

2. The apparatus of claim 1, in which the network request data structure is any of: a TCP segment, a UDP datagram, an IP packet, an Ethernet frame.

3. The apparatus of claim 1, in which the device associated with the network request data structure is determined based on at least one of: a MAC address, an IP address.

4. The apparatus of claim 1, in which the activity category comprises at least one of: an activity type, an application, a website.

5. The apparatus of claim 1, in which the activity category is further determined based on analysis of the activity content.

6. The apparatus of claim 5, in which the activity content comprises at least one of: port number, protocol identifier, application identifier.

7. The apparatus of claim 1, in which the processor-executable instructions further comprise instructions to:
determine, via the at least one processor, a user identifier associated with the device; and
wherein the network usage policy rule data structure is determined based on the user identifier.

8. The apparatus of claim 7, in which the processor-executable instructions further comprise instructions to:
determine, via the at least one processor, a user group identifier associated with the user identifier; and
wherein the network usage policy rule data structure is determined based on the user group identifier.

9. The apparatus of claim 1, in which the network usage policy rule data structure is a best matching network usage policy rule data structure.

10. The apparatus of claim 1, in which the network usage policy rule data structure comprises a plurality of matching network usage policy rule data structures.

11. The apparatus of claim 1, in which the policy rule time limit is configured to accumulate for the device.

12. The apparatus of claim 1, in which the policy rule time limit is configured to accumulate for any of: a user associated with the device, a user group associated with the user.

13. The apparatus of claim 1, in which the network usage policy rule data structure is structured as specifying a disturbance interval and a pause interval associated with the disturb period.

14. The apparatus of claim 1, in which the enforcement protocol comprises at least one of: increase latency, drop packets, rate limit.

15. The apparatus of claim 1, in which the instructions to determine the enforcement protocol further comprise instructions to determine a severity level of the enforcement protocol.

16. The apparatus of claim 1, in which the processor-executable instructions further comprise instructions to analyze impact measurement data associated with application of the enforcement protocol to the network request data structure to determine an effectiveness measure of the enforcement protocol.

17. The apparatus of claim 16, in which the processor-executable instructions further comprise instructions to adjust at least one of: the enforcement protocol specified via the policy rule data structure to utilize for the activity category, a severity level of the enforcement protocol.

18. A processor-readable non-transitory physical medium storing processor-executable instructions to:
obtain, via at least one processor, a network request data structure comprising at least a source network interface address, a destination network interface address, and activity content;
determine, via the at least one processor, a device associated with the network request data structure based on the source network interface address;
determine, via the at least one processor, an activity category associated with the network request data structure based on the destination network interface address;
determine, via the at least one processor, a network usage policy rule data structure associated with the device and applicable to the activity category;
determine, via the at least one processor, a policy rule time limit specified via the network usage policy rule data structure;
determine, via the at least one processor, that the policy time limit has been exceeded;
determine, via the at least one processor, a disturb period specified via the network usage policy rule data structure;
determine, via the at least one processor, that the disturb period has not been exceeded;
determine, via the at least one processor, an enforcement protocol specified via the policy rule data structure to utilize for the activity category; and
apply, via the at least one processor, the enforcement protocol to the network request data structure to simulate a network disruption.

19. A processor-implemented method comprising executing processor-executable instructions to:
obtain, via at least one processor, a network request data structure comprising at least a source network interface address, a destination network interface address, and activity content;
determine, via the at least one processor, a device associated with the network request data structure based on the source network interface address;
determine, via the at least one processor, an activity category associated with the network request data structure based on the destination network interface address;
determine, via the at least one processor, a network usage policy rule data structure associated with the device and applicable to the activity category;
determine, via the at least one processor, a policy rule time limit specified via the network usage policy rule data structure;
determine, via the at least one processor, that the policy time limit has been exceeded;
determine, via the at least one processor, a disturb period specified via the network usage policy rule data structure;
determine, via the at least one processor, that the disturb period has not been exceeded;
determine, via the at least one processor, an enforcement protocol specified via the policy rule data structure to utilize for the activity category; and
apply, via the at least one processor, the enforcement protocol to the network request data structure to simulate a network disruption.
